(19) United States
(12) Patent Application Publication
(10) Pub. No.: US 2004/0171386 A1
(43) Pub. Date: Sep. 2, 2004

(54) Method for identifying a station with specific functions in a wireless-based ad-hoc network, and a substation for carrying out the method

(76) Inventor: Enric Mitjana, Munchen (DE)

Correspondence Address: LERNER AND GREENBERG, P.A., POST OFFICE BOX 2480, HOLLYWOOD, FL, 33022-2480, US

(21) Appl. No.: 10/793,091

(22) Filed: Mar. 4, 2004

Related U.S. Application Data
(63) Continuation of application No. PCT/EP02/09846, filed on Sep. 3, 2002.

(30) Foreign Application Priority Data
Sep. 4, 2001 (EP) 01 121 191.9
Sep. 4, 2001 (DE) 101 43 276.3

(51) Int. Cl. H04Q 7/20

(52) U.S. Cl. 455/452.2; 455/453

(57) ABSTRACT

A method for identifying sub-stations with specific functions in an ad hoc network having at least two sub-stations, at least one of which offers the specific functions to other sub-stations, has the capacity to execute a specific function and/or a corresponding retransmission option is/are respectively communicated to the other substations by signaling. Access to another communications system, e.g. an UMTS network can, in particular, be offered as a specific function.

### CROSS-REFERENCE TO RELATED APPLICATIONS

This application is a continuation, under 35 U.S.C. § 120, of copending international application No. PCT/EP02/09846, filed Sep. 3, 2002, which designated the United States; this application also claims the priority, under 35 U.S.C. § 119, of European patent application No. 01121191.9, filed Sep. 4, 2001 and German patent application No. 101 43 276.3, filed Sep. 4, 2001; the prior applications are herewith incorporated by reference in their entirety.

### BACKGROUND OF THE INVENTION

Field of the Invention

The invention relates to a method for identifying a station with specific functions in an ad-hoc network and to a substation for carrying out the method.

Published, Non-Prosecuted British patent application No. 2 354 386 A describes a method in which the distance to a restaurant is communicated using a GPS receiver of a mobile subscriber station in an ad-hoc mobile radio communication system.

In the reference titled “Specification of the Bluetooth System, Profiles, Version 1.0B, Service Discovery Application Profile” Bluetooth Specification V 1.0B, 1 Dec. 1999 (1999-Dec.-1), the Service Discovery Protocol, as it is called, of the Bluetooth system is explained on pages 62-67.

In ad-hoc networks currently under development, multiple substations have the capacity independently to establish a radio link to other such substations without using a switching central network device. When this is done, the establishment of a radio link between two such substations in each case should occur automatically. Ad-hoc networks for small local areas, e.g. office buildings, should have the capacity to enable communication between a small number of such substations, while, under other configurations, ad-hoc networks are being developed in which a large number of substations distributed over a large area should be able to communicate with one another. A wireless or wireless-based ad-hoc network is, for example, a type of wireless local area network (WLAN). A particular advantage lies in the high level of mobility, by which the topology of the network can be changed at random. However, this also has the result that in certain places at certain times a particularly good link can exist to a large number of other substations while at the same place at other times no link to any other substation may be possible. The situation is similar as regards the quality of radio links between individual substations, so that data rates, delays and quality of service (QoS), etc. can also fluctuate sharply from time to time and from place to place.

Consideration is being given to the idea of making specific functions or specific services available for substations of such ad-hoc networks. For example, in the reference titled “Towards Mobile Ad-Hoc-WANs: Terminodes”, IEEE WCNC'2000 Conference, Chicago, September 2000, the idea was touched upon of equipping such a substation individually with Internet capability, whereby this should be an advantage to all the substations in the area of this station. It is assumed here that such a potential extension should not, however, be compulsory in order to operate the network.

There is no obvious way of implementing such an integration of an Internet function or of another function in a station such that the function is also available for other substations. First, other substations without such functions completely lack knowledge of the possibility of using such functions. Furthermore, a network path or a route has to be established between the substations needing such functions and the substations offering such functions, whereby the route may lead via a large number of intermediately located substations, such communications via multiple stations also being referred to as “hopping” or “hops”.

A comparison with other types of communications systems shows that directly transferring technologies into the field of ad-hoc network engineering is not an obvious solution. In the Internet, for example, an address of a gateway that offers a specific function or an Internet access is entered permanently in the terminals accessing it, whereby a terminal would in the present case correspond to an ad-hoc substation. If the terminal does not find the Internet Protocol (IP) address it seeks in the local area network, it forwards the packets to another gateway. The routes established here remain fixed over long periods, whereby even the defining capabilities with regard to data throughput, quality of service, etc. remain virtually static over the period. There is, however, no obvious way of transferring this to ad-hoc substations, since the advantage of ad-hoc networks lies precisely in the fact that the individual substations can be connected randomly with one another without having to use firmly defined network structures and network addresses.

Simple ad-hoc communications systems such as, for example, the communications system known under the name “Bluetooth”, serve as a substitute for cable connections, for example to access local area networks by a notebook computer and such like. Bluetooth is configured to support some capabilities with regard to Internet access. When two such stations “detect” one another, information is exchanged between the terminals about the possible services. The services involved here are services which do not change significantly over time, for example print functions or copy functions, in order to copy data from a notebook to a central memory in a network. Functions for establishing a route via multiple stations are not, however, an immediate concern in Bluetooth, since direct point-to-point connections are involved here.

Initial developments of ad-hoc networks stem from the military sphere, for example, for exchanging data on a battlefield between appropriately distributed substations. Here, the routing is determined and optimized by the GPS-determined (global positioning system) geographical positions of individual substations. This approach, however, is not always possible in indoor environments or precise enough in small networks, e.g. where there are 5 terminals in a 50 square meter room with GPS accuracies of around 100 m, since no such precise positioning can be determined.

As regards the determining of routes between two substations, examples are known from the reference titled “Towards Mobile Ad-Hoc-WANs: Terminodes”, IEEE WCNC'2000 Conference, Chicago, September 2000. A distinction is drawn between a local view and a remote view of a substation. In the case of the local view, a substation attempts to produce for itself a spatial image of the distribution of different substations in the near environment. To this end, end-system unique identifiers (EUI) of the substations in the area of the ‘neighborhood’ are determined, whereby substations in the neighborhood, or neighbors, are deemed to be substations that can be reached in a few hops. The path or route to such neighbors and their position must also be determined and stored. If required, the substations attempt to establish a remote view by identifying information from non-neighboring substations. In this case, the remote view is established e.g. on the basis of fixed geodetic points, whereby the shortest geodetic path to remote substations, if their direction is known, is sought and computed. If on this shortest geodetic path no substations are located with the facility for retransmitting data or information, a path is sought within as small as possible an angle from the destination direction, within which angle substations with a retransmitting facility are located. When a route is switched in this way, a route vector is established from a list of anchor points and/or substation identification numbers, whereby, for the later sending of user data, this list is also transmitted as header information for routing the data.

With regard to the prior art, two types of routing protocols, proactive and reactive protocols as they are called, can thus be distinguished. Proactive protocols attempt to discover a route whereby the routes discovered are constantly checked as to their constancy, irrespective of whether the routes are used or not. Examples of this in existing communications systems of other types are the traditionally known link status and distance vector protocols. The reactive protocols, by contrast, establish a route only if there is a demand for one. Examples of this are dynamic source routing (DSR) and ad-hoc on demand distance vector routing (AODV). The latter has the advantage of a lower signaling load. A disadvantage of DSR, for example, is that in the event of a request to initiate a connection the requesting source substation has first to execute a route search. This setup takes only a limited time. After a route has been found, all user packets are transmitted via the predefined route, whereby the individual data packets are forced by the header information to use the substations determined on this route. A change in the link layer as a result, for example, of the mobility of the substations, can result in one of the substations being no longer located in the appropriate position that applied at the time the connection was established. Interruptions in the route must first be communicated back to the source substation so that the latter can determine a new route for transmitting further data packets.

### SUMMARY OF THE INVENTION

It is accordingly an object of the invention to provide a method for identifying a station with specific functions in a wireless-based ad-hoc network, and a substation for carrying out the method that overcome the above-mentioned disadvantages of the prior art methods and devices of this general type.

With the foregoing and other objects in view there is provided, in accordance with the invention, a method for identifying and/or using substations with specific functions in an ad-hoc network. The ad-hoc network has at least two substations, at least one of the substations offers the specific functions to other ones of the substations. The method includes communicating a capacity to execute a specific function to other ones of the substations and/or a corresponding retransmission option from a substation with such a function to the other substations by signaling. Additional information about a quality of service offered is communicated with the signaling.

The invention therefore proposes a method for identifying a substation with specific functions and an improved routing method for establishing and maintaining the routes.

The emission of messages and/or information about the specific function of a substation supplies surrounding substations with the necessary data for recognizing on the one hand that a specific function of an external substation is usable and on the other hand which substation and/or services is/are involved.

When the functional information is transmitted via intermediately switched further substations, a counter value is usefully also incremented by each of the intermediately switched substations so that the receiving substation can recognize by use of the counter value how many hops away the substation which is offering the specific service or the specific function is. This enables on the one hand, where multiple routes are possible, the selection of a route with the fewest possible hops and on the other an assessment to be made of the security of the link over a longer period as well as of the quality of the link.

The use of such a procedure with signaling of available special services via the substation which offers the specific function and/or the specific services, or via further substations which enable a link to be switched between such a substation and a station requesting the specific service or the specific function is particularly advantageous in small local area networks with a small number of subscribers or number of ad-hoc substations, since in such small networks the loading of the network by the signaling is not critical in terms of the overall capacity of the network.

The forwarding of information which is available in a substation to a directly adjacent substation, which in turn accepts this data or information and forwards it as data of its own to further substations directly adjacent to it, enables effective routing which displays advantageous aspects both of a conventional short-sighted routing method and of a conventional long-sighted routing method. Through a periodic exchange of information with neighboring substations, each of the substations knows which function the directly adjacent substation has itself or can switch. Consequently, in the individual substations only the information on functions and services of its own and of directly adjacent substations has to be stored, whereby when such functions and services are retransmitted or offered further to third directly adjacent substations, identification information is usefully transmitted on the one hand with the routing data and on the other hand stored in the corresponding substation. This enables on the one hand routing without regional knowledge of the further neighborhood and on the other hand routing according to the conventional routing method for distantly located substations with in each case rigid routes and costly header information containing all the necessary data on the route. Each substation routes or forwards its own or incoming data packets according to its own most up-to-date knowledge. The source substation does not have to enter a detailed route in each individual packet header, which in turn results in a reduced loading on the system. In particular, the ratio of information load to payload in the data packets is significantly improved. In the above, a directly adjacent substation is deemed to refer to a substation that is accessible by a direct link with no hops.

In accordance with an added mode of the invention, there is the step of executing the signaling through a message channel and/or a communication channel.

In accordance with an additional mode of the invention, there is the step of communicating further additional information about the specific function offered and/or number of hops required with the signaling. The specific function consists in enabling access to at least one of a foreign communication network and a data store.

In accordance with a further mode of the invention, there is the step of executing a request for the specific function by a requesting substation depending on possible qualities of service, the number of hops required and/or special specific functions.

In accordance with another mode of the invention, there are the steps of performing the signaling from the substation having the specific function with a relay station to a further substation, and changing the additional information about the quality of service offered.

With the foregoing and other objects in view there is further provided, in accordance with the invention, an ad-hoc substation. The substation contains a transceiver for establishing a radio link to at least one other substation, a functional module for providing a specific function, and a signaling device for generating signaling with which the specific function is signaled to other substations. The signaling contains additional information about a quality of service offered.

In accordance with a concomitant feature of the invention, the functional module has as a specific function access to another communications system. Preferably, the communications system is an UMTS network.

Other features which are considered as characteristic for the invention are set forth in the appended claims.

Although the invention is illustrated and described herein as embodied in a method for identifying a station with specific functions in a wireless-based ad-hoc network, and a substation for carrying out the method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is an illustration showing a configuration of ad-hoc substations, wherein one of the stations is furnished with a specific function according to the invention; and

FIG. 2 diagrammatically shows signaling information.

### DESCRIPTION OF THE PREFERRED EMBODIMENTS

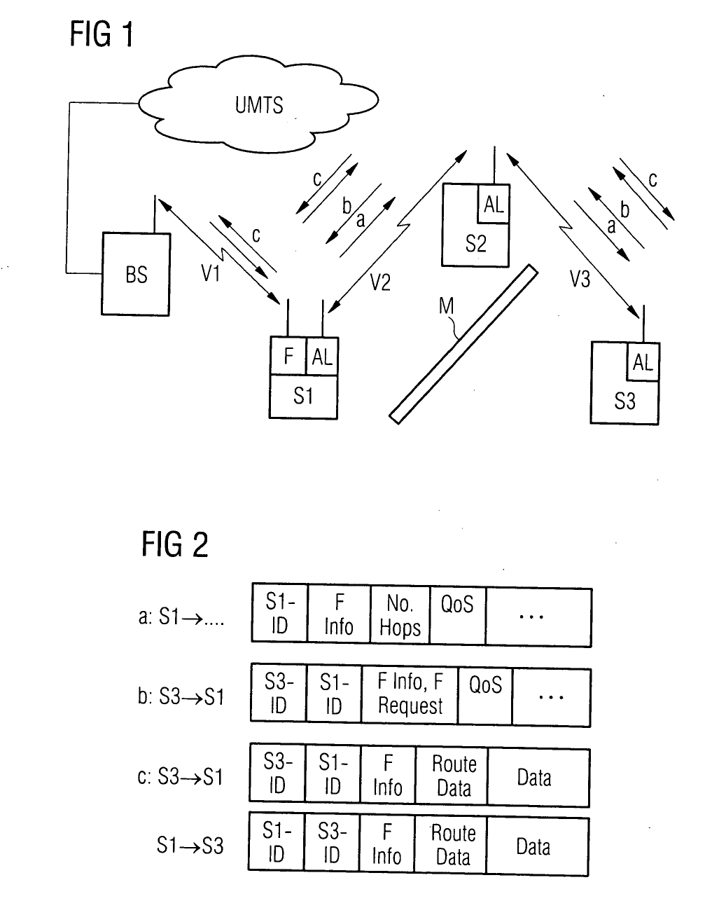

Referring now to the figures of the drawing in detail and first, particularly, to FIG. 1 thereof, there is shown an ad-hoc network which contains two or more substations S1-S3 which can establish radio links V2, V3 between one another. Additional network devices for administering the ad-hoc network are advantageously not required. The entire network administration in respect of a single one of these substations S1-S3 takes place in the individual substations S1-S3 themselves. The substations S1-S3 usefully have appropriate transceivers for this purpose with control and storage devices, whereby these devices are outlined as an ad-hoc network module AL.

In the embodiment shown, a radio link V2 is established between the first substation S1 and the second substation S2. A further radio link V3 is established between the second substation S2 and the third substation S3. The second substation S2 can communicate independently with the two directly adjacent substations S1 and S3 via the radio links V2, V3, but can, if appropriately released by the user of the second substation S2, also function as a relay station in order to establish a radio link V2+V3 from the first substation S1 to the third substation S3 for their communication with one another. Direct communication via a direct radio interface between the first substation S1 and the third substation S3 is configured not to be possible in the present embodiment on account of the distance between the substations being too great or on account of a radio barrier M between the substations.

As shown, the first substation S1 is to be equipped with a specific function in a functional module F. For example, the function is to consist in the first substation S1 being able to establish via the functional module F a radio link V1 with a universal mobile telecommunications system (UMTS) network. The corresponding distant terminal would, for example, be a base station BS of the UMTS network. The provision of a database as a specific function is, however, also possible.

As a result of the offering of the specific function, not only can the first substation S1 access the UMTS network, but the user of the first substation S1 can also enable this for the further substations S2, S3, whereby the first substation S1 is then operated as a relay station or gateway. Usefully, the gateway function of the first substation S1 can optionally also be deactivated by the users of the substation, for example in order not to use up the power of the substation's battery too quickly.

Advantageously, the specific functional capacity of the first substation S1 is communicated to the further substations S2, S3 which do not possess such a function. This can be done, for example, via a message or broadcast channel or a point-to-point channel via which communication takes place with the adjacent stations S2. Advantageously, channels can be accessed for this functional signaling which are provided e.g. for configuring routing tables of the substations S2, S3 or which as a shared channel enable more or less orderly access to the radio interface so as to be able at any time to take into account changes in the network topology and constantly to supply the individual substations S1-S3 with up-to-date routing information. Advantageously, the information about the specific function of the first substation S1 is regularly emitted repeatedly and updated as required. In particular, additional information about the quality of the radio interface V1 between the first substation S1 and the base station BS of the UMTS network and/or the quality in general of the specific function can also be communicated with the information about the capacity for executing the specific function to the further substations S2, S3.

In FIG. 1, the signaling of the functional capacity is shown by an arrow a between the first substation S1 and the second substation S2. Insofar as the second substation S2 is capable of serving for this specific function as a relay station and has also been released for this purpose by the user, the second substation S2 can forward corresponding functional information to further substations, here the third substation S3 (arrow a).

FIG. 2 shows sample information data for the various signaling and data blocks. The first signaling block describes signaling of the specific function to other substations as shown in FIG. 1 by the arrow a. As well as specifying a station identification number S1-ID for the substation S1 which offers the specific function, further information fields are provided. These can relate, for example, to general information about the specific function available (F-Info), the number of hops (No. hops), the quality of service (QoS) of the specific function offered, a data rate, etc.

With regard to the specification of the hops required, each relay station S2 usefully updates the value entered in this field No. hops by adding one. A substation S3 that is remote from the first substation S1 equipped with the specific function and would like to access the specific function can thus detect whether a direct link or an indirect link with one or more hops is involved. The greater the number of hops, the greater the risk of a connection being lost as a result of the failure of the relay station S2. Also, where a greater number of hops is required, there is also the risk of data errors in transmission by the individual relay stations S2. Each hop also signifies an additional delay, which can be critical in the case of real-time services. Unnecessary hops have accordingly to be avoided with certain services, which advantageously can be taken into account by continuously adaptable routing.

It is advantageous also to take into account the number of hops required between a requesting substation S3 and a substation S1 acting as a gateway in order to save resources, for example the battery of other subscribers' substations S2 which serve as relay stations. The lower the number of hops, the lower the total consumption of power of the total of all the substations S1-S3 involved in the transmission. The information about the number of hops required can advantageously also be used to select the various routes available, for example if different routes via different relay stations are possible between the substation S1 offering the specific function and the substation S3 requesting the specific function. As well as the number of hops required, the possible quality of service or information about the maximum possible data rate, for example, can also be used as a criterion for selection in cases where different routes are available.

A further criterion for determining whether accessing a remote substation S1 with the specific function is appropriate is obtained by the requesting third substation S3 through information on the possible quality of service QoS. In particular, the information about the quality of service QoS available can also be changed by relay stations S2, if a relay station enables the retransmission of data relating to a specific function but cannot transmit the required data rate or quality of service to the standard originally possible. If the requested quality of services cannot be offered, then a reduction can also be made to at least a necessary quality of service.

If a substation, here the third substation S3, would like to access the specific function of another substation, here the first substation S1, the requesting third substation S3 usefully sends a request (arrow b) to the first substation S1 offering the function. In the present embodiment, transmission of the request b is in turn carried out via the second substation S2 which serves as a relay station. Usefully, with the request a check is simultaneously made whether the first substation S1 offering the specific function can provide the function in the required form and whether the route suffices for the parameters required. For example, access could be necessary to specific types of services in the remote foreign UMTS network, so that a check would have to be made whether the first substation S1 with the specific function which is serving as a gateway can request only general services or can also request the specially requested service from the UMTS network. Furthermore, the issuing of the request b can also serve to check the reliability of the route or path to the first substation S1 offering the specific function.

As can be seen from FIG. 2, a sample request b, which is sent from the third substation S3 requesting the specific function to the first substation S1 offering the specific function, can contain a large amount of information. This can, in particular, be sender information, e.g. a sender identification number S3-ID, a destination address, for example the identification number S1-ID of the substations S1 offering the specific function, a functional request F-Info, a request for at least a necessary quality of service QoS, etc.

The actual routing can advantageously be executed using any routing procedures. After a route has been stipulated and a radio link established via radio interfaces V2, V3, packets containing user data and signaling can be exchanged between the communicating substations S1, S3. This is shown by arrows c. In the event that the first substation S1 offering the specific function enables access to a foreign network, for example the UMTS network, it functions as a relay station and enables access and data transmission to the UMTS network. The data transmission c can be executed in one direction only or else in both directions.

Sample headers for data transmission blocks are shown in FIG. 2, with sender and destination addresses S3-ID and S1-ID usefully being specified in the headers. The header can also contain details about the identification of the specific function, about the route to be used, etc.

According to one specific embodiment, no fixed route is specified, but transmission carried out from substation to substation. To this end, tables are created in the individual substations S1-S3, in which tables the substation's own or a switchable external functional capability or link request is filed. A special information identification number is filed together with this information. Also entered in the table are the other substation from which such a request or information has been received and the other substation to which such information or such a request has been sent or forwarded. As a result, each substation S1-S3 no longer has to have knowledge of all the substations in the neighborhood or of possible routes including all the identification numbers of all substations on the route. In such a case, only a request or information identification number and the identification number of the sender are then entered in the header in order to enable automatic routing.

With a procedure of this type it is possible that the substation S3 which needs the specific function knows nothing of the existence of the substation S1 providing the specific function. The substation S3 needing the specific function has to know only that it can access the specific function via the substation S2 directly adjacent to it. The intermediately located substation S2 knows in turn that the function is offered by the supplying substation S1 and forwards the corresponding signaling, information and data packets. This brings a saving in the routing overheads of the network. In other words, a substation has in the case of this embodiment only to know that the function is offered somewhere in the network and via which neighboring substation and/or via which next hop it can obtain the switched function.

Both the signaling of a specific function and the request for such a specific function are usefully emitted repeatedly and regularly so as continuously to provide information about specific functions and continuously to enable optimal routing and access to specific functions.

I claim:

1. A method for identifying and/or using substations with specific functions in an ad-hoc network, the ad-hoc network having at least two substations, at least one of the substations offering the specific functions to other ones of the substations, the method which comprises the steps of:
communicating at least one of a capacity to execute a specific function to other ones of the substations and a corresponding retransmission option from a substation with such a function to the other substations by signaling; and
communicating additional information about a quality of service offered with the signaling.

2. The method according to claim 1, which further comprises executing the signaling through at least one of a message channel and a communication channel.

3. The method according to claim 1, which further comprises communicating further additional information about the specific function offered and/or number of hops required with the signaling.

4. The method according to claim 3, wherein the specific function consists in enabling access to at least one of a foreign communication network and a data store.

5. The method according to claim 3, which further comprises executing a request for the specific function by a requesting substation depending on possible qualities of service, the number of hops required and/or special specific functions.

6. The method according to claim 1, which further comprises:
performing the signaling from the substation having the specific function with a relay station to a further substation; and
changing the additional information about the quality of service offered.

7. An ad-hoc substation, comprising:
a transceiver for establishing a radio link to at least one other substation;
a functional module for providing a specific function; and
a signaling device for generating signaling with which the specific function being signaled to other substations, the signaling containing additional information about a quality of service offered.

8. The ad-hoc substation according to claim 7, wherein said functional module has as a specific function access to another communications system.

9. The ad-hoc substation according to claim 8, wherein the communications system is an UMTS network.
